(19) United States
(12) Patent Application Publication
(10) Pub. No.: US 2025/0322032 A1
(43) Pub. Date: Oct. 16, 2025

(54) SECURE ATTRIBUTE SELECTION SYSTEM, SECURE ATTRIBUTE SELECTION APPARATUS, SECURE ATTRIBUTE SELECTION METHOD, AND PROGRAM

(71) Applicant: NIPPON TELEGRAPH AND TELEPHONE CORPORATION, Tokyo (JP)

(72) Inventor: Koki HAMADA, Tokyo (JP)

(73) Assignee: NIPPON TELEGRAPH AND TELEPHONE CORPORATION, Tokyo (JP)

(21) Appl. No.: 18/867,124

(22) PCT Filed: May 24, 2022
(86) PCT No.: PCT/JP2022/021238

§ 371 Date: Nov. 19, 2024

(51) Int. Cl. G06F 17/16

(52) U.S. Cl. CPC G06F 17/16

(57) ABSTRACT

A first matrix calculation means that calculates a share of a matrix E in which each row satisfies a predetermined condition using a share of a matrix X representing N pieces of data and a share of a column vector ^{→}g representing groups obtained by grouping the N pieces of data, second matrix calculation means that calculates a share of a matrix Y and a share of a matrix U in which each row satisfies the predetermined condition, a third matrix calculation means that calculates a share of a matrix S in which each row satisfies the predetermined condition, and a first vector calculation means that calculates a share of a column vector ^{→}z with an attribute number of an attribute having a best evaluation value among K attributes selected at random in a group to which an i-th data belongs as an i-th element are included.

### TECHNICAL FIELD

The present invention relates to a secret calculation technique, and more particularly, to a technique for secretly calculating selection of an attribute based on an evaluation value.

### BACKGROUND ART

Secret computation is a method of obtaining a calculation result of calculation designated without restoring encrypted numerical values (for example, see NPL 1). In the method of NPL 1, encryption is executed to distribute a plurality of pieces of information with which numerical values can be restored to three secret calculation devices, and the information can be retained in a state in which results of addition or subtraction, constant addition, multiplication, constant multiplication, logical operation (NOT, AND, OR, and exclusive OR), or data format conversion (integers or binary numbers) are distributed to the three secret calculation devices without restoring the numerical values, that is, in an encrypted state. In general, a distribution number is not limited to 3, and W (W is a predetermined constant of 3 or more) can be used. A protocol for implementing secret calculation by cooperative calculation by W secret calculation devices is called a multi-party protocol.

Secret calculation is conceivable in which an attribute having a best evaluation value is selected from K attributes selected at random for each group with regard to N pieces of data configured by M attributes grouped into a predetermined number of groups. In this case, if the evaluation values are calculated for all the M attributes for each group, an attribute having a best evaluation value can be selected from the K attributes selected at random for each group.

### CITATION LIST

### Non Patent Literature

[NPL 1] Koji Chida, Koki Hamada, Dai Ikarashi, and Katsumi Takahashi, “A Three-Party Secure Function Evaluation with Lightweight Verifiability Revisited”, In CSS, 2010.

### SUMMARY OF INVENTION

### Technical Problem

However, the above-described method is not efficient since evaluation values are calculated for all the M attributes for each group and a calculation amount becomes large.

An object of the present invention is to provide a technique for efficiently executing secret calculation for selecting an attribute having a best evaluation value among K attributes selected at random for each group with regard to N pieces of data configured by M attributes grouped into a predetermined number of groups.

### Solution to Problem

According to an aspect of the present invention, in a secret attribute selection system, N (where N is an integer of 1 or more) is the number of pieces of data, M (where M is an integer of 1 or more) is the number of attributes included in data, X=(^{→}x₁, . . . , ^{→}x_{N})^{t} (where ^{→}xᵢ (i=1, . . . , N) is a row vector of length M representing i-th data, N pieces of data ^{→}x₁, . . . , ^{→}x_{N} are grouped into a predetermined number of groups, and data belonging to the same group is arranged to be adjacent to each other) is a matrix of N rows and M columns representing N pieces of data ^{→}x₁, . . . , ^{→}x_{N}, and ^{→}g=(g₁, . . . , g_{N})^{t} (where gᵢ (i=1, . . . , N) is 1 in a case where the i-th data ^{→}xᵢ is head data of a certain group and is 0 in other cases) is a column vector of length N representing groups obtained by grouping N pieces of data ^{→}x₁, . . . , ^{→}x_{N}. The secret attribute selection system includes three or more secret attribute selection devices and calculates a share [[^{→}z]] of the column vector ^{→}z=(z₁, . . . , z_{N})^{t} of length N in which an attribute number of an attribute having a best evaluation value among K attributes (where K is an integer of 1 or more and M or less) selected at random in a group to which the i-th data ^{→}xᵢ belongs is an i-th element zᵢ, from a share [[X]] of the matrix X representing N pieces of data ^{→}x₁, . . . , ^{→}x_{N}, and a share [[^{→}g]] of the column vector-g representing groups obtained by grouping the N pieces of data ^{→}x₁, . . . , ^{→}x_{N}. The secret attribute selection system includes a first matrix calculation means configured to calculate, using the share [[g]], a share [[E]] of a matrix E=(^{→}e₁, . . . , ^{→}e_{N})^{t} of N rows and M columns (where ^{→}eᵢ (i=1, . . . , N) is a row vector of length M representing K attributes selected at random in a group to which the i-th data ^{→}xᵢ belongs, and a j-th element e_{i,j} of the row vector ^{→}eᵢ is 1 in a case where a j-th attribute is a selected attribute and is 0 in other cases). V=(^{→}v₁, . . . , ^{→}v_{N})^{t} (where ^{→}vᵢ (i=1, . . . , N)) is a row vector (1, 2, . . . , M) of length M in which attribute numbers of the attributes of the i-th data ^{→}xᵢ are arranged in a number order of the attributes) is a matrix of N rows and M columns. The secret attribute selection system includes a second matrix calculation means configured to calculate, using the share [[E]], a share [[Y]] of a matrix Y=(^{→}y₁, . . . , ^{→}y_{N})^{t} of N rows and K columns (where ^{→}yᵢ (i=1, . . . , N) is a row vector of length K in which values of the i-th data ^{→}xᵢ with respect to K attributes selected at random in a group to which the i-th data ^{→}xᵢ belongs are arranged in a number order of the attributes) from the share [[X]] and calculate, using the share [[E]], a share [[U]] of a matrix U=(^{→}u₁, . . . , ^{→}u_{N})^{t} of N rows and K columns (where ^{→}uᵢ (i=1, . . . , N) is a row vector of length K in which attribute numbers of K attributes selected at random in a group to which the i-th data ^{→}xᵢ belongs are arranged in a number order of the attributes) from the share [[V]]. The secret attribute selection system includes a third matrix calculation means configured to calculate a share [[S]] of a matrix S=(^{→}s₁, . . . , ^{→}s_{N})^{t} of N rows and K columns (where ^{→}sᵢ (i=1, . . . , N) is a row vector of length K in which evaluation values of a group with respect to K attributes selected at random in the group to which the i-th data X belongs are arranged in a number order of the attributes) from the share [[Y]]. The secret attribute selection system includes a first vector calculation means configured to calculate a share [[^{→}z]] from the share [[S]] using the share [[Y]] and the share [[U]].

### Advantageous Effects of Invention

According to the present invention, it is possible to efficiently execute secret calculation for selecting an attribute having a best evaluation value among K attributes selected at random for each group with regard to N pieces of data configured by M attributes grouped into a predetermined number of groups.

### BRIEF DESCRIPTION OF DRAWINGS

FIG. 1 is a block diagram illustrating a configuration of a secret attribute selection system 10.

FIG. 2 is a block diagram illustrating a configuration of a secret attribute selection device 100ᵢ.

FIG. 3 is a flowchart illustrating an operation of the secret attribute selection system 10.

FIG. 4 is a diagram illustrating an example of a functional configuration of a computer which implements each device in an embodiment of the present invention.

### DESCRIPTION OF EMBODIMENTS

Hereinafter, embodiments of the present invention will be described in detail. Constituent elements having the same functions are denoted by the same reference numerals and repeated explanations thereof will be omitted.

A notation method in this specification will be described before the embodiments are described.

\hat{ }(caret) indicates a superscript. For example, x^{y\hat{ }z} indicates that y^{z} is a superscript to x and x_{y\hat{ }z} indicates that y_{z} is a subscript to x. _ (underscore) indicates a subscript. For example, x^{y_z} indicates that y^{z} is a superscript to x and x_{y_z} indicates that y_{z} is a subscript to x.

“\hat{ }” and “˜” of superscripts as in \hat{ }x and ˜x for a certain character x should be written directly above “x,” but \hat{ }x and ˜x are written due to restrictions on description notation in the specification.

### TECHNICAL BACKGROUND

### <<Secret Calculation>>

The secret calculation in each embodiment of the present invention is constructed by combing calculations of existing secret calculations. Calculation necessary for the secret calculation is concealment, addition, subtraction, multiplication, division, logical operation (NOT, AND, OR, and exclusive OR), a comparative operation (=, <, >, ≤, ≥), secret stable sorting, or a Group-wise sum operation. Hereinafter, several operations including notation will be described.

### [Concealment]

It is assumed that [[X]] is a value obtained by concealing x by secret sharing (hereinafter referred to as a “share” of x). Any method can be used as a secret sharing method. For example, Shamir secret sharing on GF (2⁶¹−1) or duplicate secret sharing on Z₂ can be used.

A plurality of secret sharing methods may be used in combination in one algorithm. In this case, it is assumed that the secret sharing methods can be interconverted appropriately.

Further, for N dimensional vector ^{→}x=(x₁, . . . , x_{N}), [[^{→}x]]=([[x₁]], . . . , [[x_{N}]]) is assumed. That is, [[^{→}x]] is a vector that has a share [[xₙ]] of an n-th element xₙ of x as an n-th element. Similarly, for M×N matrix A=(a_{m,n}) (1≤m≤M and 1≤n≤N), [[A]] is assumed to be a matrix that has a share [[a_{m,n}]] of an (m, n)-th element a_{m,n} of A as an (m, n)-th element.

Here, x is referred to as a plaintext of [[x]].

As a method of obtaining [[x]] from x (concealment) and a method of obtaining x from [[x]] (restoration), specifically, there are methods described in NPL 1 and Reference NPL 1. (Reference NPL 1: Shamir, A., “How to share a secret”, Communications of the ACM, Vol. 22, No. 11, pp. 612 to 613, 1979.)

[Addition, Subtraction, Multiplication, and Division] Addition [[x]]+[[y]] by secret calculation receives [[x]] and [[y]] as an input and outputs [[x+y]]. Subtraction [[x]]-[[y]] by secret calculation receives [[x]] and [[y]] as an input and outputs [[x-y]]. Multiplication [[x]]×[[y]] (also expressed as mul([[x]], [[y]])) by secret calculation receives [[x]] and [[y]] as an input and outputs [[x×y]]. Division [[x]]/[[y]] (also expressed as div ([[x]], [[y]])) by secret calculation receives [[x]] and [[y]] as an input and outputs [[x/y]].

As specific methods of addition, subtraction, multiplication and division, there are methods described in Reference NPL 2 and Reference NPL 3.

(Reference NPL 2: Ben-Or, M., Goldwasser, S. and Wigderson, A., “Completeness theorems for non-cryptographic fault-tolerant distributed computation”, Proceedings of the twentieth annual ACM symposium on Theory of computing, ACM, pp. 1 to 10, 1988.)

(Reference NPL 3: Gennaro, R., Rabin, M. O. and Rabin, T., “Simplied VSS and fast-track multiparty computations with applications to threshold cryptography”, Proceedings of the seventeenth annual ACM symposium on Principles of distributed computing, ACM, pp. 101 to 111, 1998)

### [Logical Operations]

In negative not [[x]] by secret calculation, [[x]] is received as an input and [[not (x)]] is output. In logical product and ([[x]], [[y]]) by secret calculation, [[x]] and [[y]] are received as an input and [[and (x, y)]] is output. In logical sum or ([[x]], [[y]]) by secret calculation, [[x]] and [[y]] are received as an input and [[or (x, y)]] is output. In exclusive logical sum xor ([[x]], [[y]]) by secret calculation, [[x]] and [[y]] are received as an input and [[xor(x, y)]] is output.

The logical operation can be easily configured by combining addition, subtraction, multiplication, and division.

### [Comparative Operation]

In equal sign determination by secret calculation=([[x]], [[y]]) (which is expressed as equal ([[x]], [[y]])), [[x]] and [[y]] are received as an input, and [[1]] is output in the case of x=y, and [[0]] is output in the other cases. In comparison <([[x]], [[y]]) by secret calculation, [[x]] and [[y]] are received as an input, [[1]] is output in the case of x<y, and [[0]] is output in the other cases. In comparison >([[x]], [[y]]) by secret calculation, [[x]] and [[y]] are received as an input, [[1]] is output in the case of x>y, and [[0]] is output in the other cases. In comparison ≤([[x]], [[y]]) by secret calculation, [[x]] and [[y]] are received as an input, [[1]] is output in the case of x≤y, and [[0]] is output in the other cases. In comparison ≥([[x]], [[y]]) by secret calculation, [[x]] and [[y]] are received as an input, [[1]] is output in the case of x≥y, and [[0]] is output in the other cases.

The comparison operation can be easily configured in combination with the logical operations.

### [Secret Stable Sorting]

The secret stable sorting is a stable sorting in secret calculation. The fact that the share [[^{→}y]] of an N-dimensional vector ^{→}y=(y₁, . . . , y_{N}) is a vector obtained by executing secret stable shorting on a share [[x]] of an N-dimensional vector ^{→}x=(x₁, . . . , x_{N}) for a share [[^{→}k]] of an N-dimensional vector ^{→}k=(k₁, . . . , k_{N}) means that the share [[^{→}y]] is a vector obtained by executing the stable sorting on the share [[^{→}x]] using a premutation of {1, . . . , N} in which the share [[^{→}k]] is subjected to stable sorting.

As a specific method of the secret stable sorting, there is a method described in Reference NPL 4.

(Reference NPL 4: Koji Chida, Koki Hamada, Dai Ikarashi, Ryo Kikuchi, Naoto Kiribuchi, and Benny Pinkas, “An Efficient Secure Three-Party Sorting Protocol with an Honest Majority,” IACR Cryptol. ePrint Arch., 2019)

### [Group-Wise Sum Operation]

In a Group-wise sum operation, assuming an N-dimensional vector ^{→}x=(x₁, . . . , x_{N}) (where N elements x₁, . . . , x_{N} are grouped into a predetermined number of groups and elements belonging to the same group are arranged to be adjacent to each other) and an N-dimensional vector ^{→}g=(g₁, . . . , g_{N}) (where gₙ (n=1, . . . , N) is 1 in a case where an n-th element x, is head data of a certain group and is 0 in the other cases), [[^{→}x]] and [[^{→}g]] are input and the share [[^{→}y]] of an N-dimensional vector ^{→}y=(y₁, . . . , y_{N}) (where yₙ (n=1, . . . , N) is a sum of elements of a group to which the n-th element xₙ belongs) is output.

As a specific method of the Group-wise sum operation, there is a method described in Reference NPL 5.

(Reference NPL 5: Koki Hamada, Dai Ikarashi, Ryo Kikuchi, and Koji Chida, “Efficient decision tree training with new data structure for secure multi-party computation,” arXiv: 2112.12906 [cs. CR], 2021.)

By applying the Group-wise sum operation for each row or each column, the Group-wise sum operation can also be defined for a matrix.

### First Embodiment

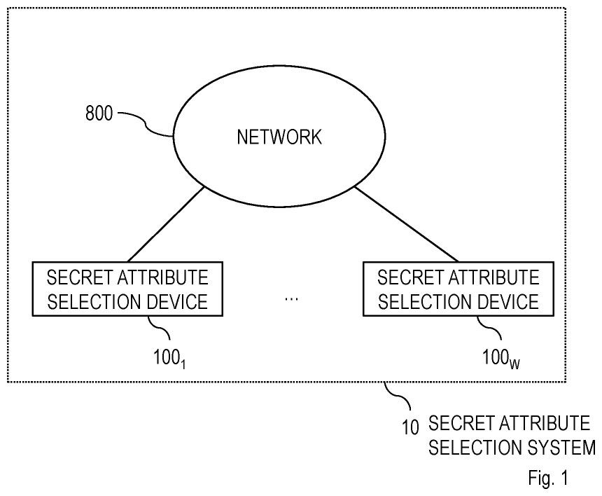

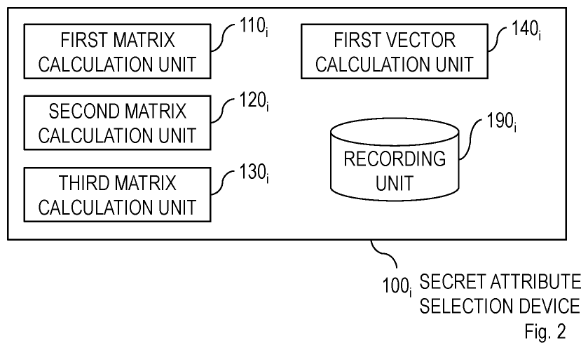

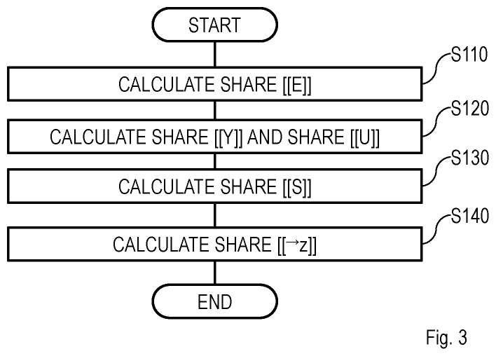

Hereinafter, the secret attribute selection system 10 will be described with reference to FIGS. 1 to 3. FIG. 1 is a block diagram illustrating a configuration of the secret attribute selection system 10. The secret attribute selection system 10 includes W (where W is a predetermined integer of 3 or more) secret attribute selection devices 100₁, . . . , and 100_{W}. The secret attribute selection devices 100₁, . . . , and 100_{W} are connected to a network 800 to be able to communicate with each other. The network 800 may be, for example, a communication network such as the Internet or a broadcast communication path. FIG. 2 is a block diagram illustrating a configuration of a secret attribute selection device 100; (where 1≤i≤w). FIG. 3 is a flowchart illustrating an operation of the secret attribute selection system 10.

As illustrated in FIG. 2, the secret attribute selection device 100ᵢ includes a first matrix calculation unit 110ᵢ, a second matrix calculation unit 120ᵢ, a third matrix calculation unit 130ᵢ, a first vector calculation unit 140ᵢ, and a recording unit 190ᵢ. Each constituent unit of the secret attribute selection device 100ᵢ excluding the recording unit 190ᵢ is configured to execute an operation required for secret calculation, that is, an operation required for implementing a function of each constituent unit among at least the concealment, the addition, the subtraction, the multiplication, the division, the logical operations, the comparative operation, secret stable sorting, and the Group-wise sum operation. As a specific functional configuration for implementing individual operations in the present invention, a configuration capable of executing an existing algorithm including an algorithm disclosed in, for example, each of NPL1 and Reference NPLs 1 to 5 suffices. Since these are the configurations of the related art, detailed description thereof will be omitted. The recording unit 190ᵢ is a constituent unit that records information necessary for processing of the secret attribute selection device 100ᵢ.

The secret attribute selection system 10 implements secret calculation of attribute selection which is a multi-party protocol through cooperative calculation by W secret attribute selection devices 100ᵢ. Therefore, a first matrix calculation means 110 (not illustrated) of the secret attribute selection system 10 includes first matrix calculation units 110₁, . . . , and 110_{W}, the second matrix calculation means 120 (not illustrated) includes second matrix calculation units 120₁, . . . , and 120_{W}, the third matrix calculation means 130 (not illustrated) includes third matrix calculation units 130₁, . . . , and 130_{W}, and a first vector calculation means 140 (not illustrated) includes first vector calculation units 140₁, . . . , and 140_{W}.

N (where N is an integer of 1 or more) is the number of pieces of data, M (where M is an integer of 1 or more) is the number of attributes included in data, X=(^{→}x₁, . . . , ^{→}x_{N})^{t} (where ^{→}xᵢ (i=1, . . . , N) is a row vector of length M representing i-th data, N pieces of data ^{→}x₁, . . . , ^{→}x_{N} are grouped into a predetermined number of groups, and data belonging to the same group is arranged to be adjacent to each other) is a matrix of N rows and M columns representing N pieces of data ^{→}x₁, . . . , ^{→}x_{N}, and ^{→}g=(g₁, . . . , g_{N}) is 1 in a case where the i-th data ^{→}xᵢ is head data of a certain group and is 0 in other cases) is a column vector of length N representing groups obtained by grouping N pieces of data ^{→}x₁, . . . , ^{→}x_{N}. The secret attribute selection system 10 calculates a share [[^{→}z]] of the column vector ^{→}z=(z₁, . . . , z_{N})^{t} of length N in which an attribute number of an attribute having a best evaluation value among K attributes (where K is an integer of 1 or more and M or less) selected at random in a group to which the i-th data ^{→}xᵢ belongs is an i-th element zᵢ, from a share [[X]] of the matrix X representing N pieces of data ^{→}x₁, . . . , ^{→}x_{N}, and a share [[^{→}g]] of the column vector g representing groups obtained by grouping the N pieces of data ^{→}x₁, . . . , ^{→}x_{N}. The share [[X]] and share [[^{→}g]] may be recorded in advance in the recording unit 190ᵢ. The letter t on the right side of a vector or a matrix as in t of (^{→}x₁, . . . , ^{→}x_{N}), for example, indicates transposition.

Hereinafter, an operation of the secret attribute selection system 10 will be described with reference to FIG. 3.

In S110, the first matrix calculation means 110 calculate, using the share [[^{→}g]], a share [[E]] of a matrix E=(^{→}e₁, . . . ^{→}e_{N})^{t} of N rows and M columns (where ^{→}eᵢ (i=1, . . . , N) is a row vector of length M representing K attributes selected at random in a group to which the i-th data ^{→}xᵢ belongs, and a j-th element e_{i,j} of the row vector ^{→}eⱼ is 1 in a case where a j-th attribute is a selected attribute and is 0 in other cases). For example, the first matrix calculation means 110 generates a share [[D]] of a matrix D=(^{→}d₁, . . . , ^{→}d_{N})^{t} of N rows and M columns (where ^{→}dᵢ (i=1, . . . , N) is a row vector of length M in which K elements selected at random among M elements are 1 and the other M-K elements are 0), calculates, using the share [[^{→}g]], a share [[D′]] of a matrix D′=(^{→}d′₁, . . . , ^{→}d′_{N})^{t} of N rows and M columns (where ^{→}d′ᵢ (i=1, . . . , N) is ^{→}dᵢ in a case where gᵢ=1 and is ^{→}0 in a case where gᵢ=0 (here, ^{→}0 is a row vector of length M where all elements are 0)) from the share [[D]], and calculates a share [[E]] from the share [[D′]] using the share [[g]]. When the share [[E]] is calculated from the share [[D′]], for example, a Group-wise sum operation can be used.

In this case, ^{→}eᵢ (i=1, . . . , N) is a row vector in which that K elements among M elements are 1 and the other M-K elements are 0. When i-th data ^{→}xᵢ and j-th ^{→}xⱼ belong to the same group, ^{→}eᵢ=^{→}eⱼ.

In S120, setting V=(^{→}v₁, . . . , ^{→}v_{N})^{t} (where ^{→}vᵢ (i=1, . . . , N) is a row vector (1, 2, . . . , M) of length M in which attribute numbers of the attributes of the i-th data ^{→}xᵢ are arranged in a number order of the attributes) is a matrix of N rows and M columns, the second matrix calculation means 120 calculates, using the share [[E]] calculated in S110, a share [[Y]] of a matrix Y=(^{→}y₁, . . . , ^{→}y_{N})^{t} of N rows and K columns (where ^{→}yᵢ (i=1, . . . , N) is a row vector of length K in which values of the i-th data ^{→}xᵢ with respect to K attributes selected at random in a group to which the i-th data ^{→}xᵢ belongs are arranged in a number order of the attributes) from the share [[X]] and calculate, using the share [[E]], a share [[U]] of a matrix U=(^{→}u₁, . . . , ^{→}u_{N})^{t} of N rows and K columns (where ^{→}uᵢ (i=1, . . . , N) is a row vector of length K in which attribute numbers of K attributes selected at random in a group to which the i-th data ^{→}xᵢ belongs are arranged in a number order of the attributes) from the share [[V]]. For example, the second matrix calculation means 120 calculates the share [[Y]] by setting, as the share [[^{→}yᵢ]] (i=1, . . . , N), a row vector of length K in which elements from M−K+1-th to M-th of a vector obtained through secret stable sorting of the share [[x]] with respect to the share [[^{→}eᵢ]] are arranged in order, and calculates the share [[U]] by setting, as the share [[uᵢ]] (i=1, . . . , N), a row vector of length K in which elements from M−K+1-th to M-th of a vector obtained through secret stable sorting of the share [[^{→}vᵢ]] with respect to the share [[^{→}eᵢ]] are arranged in order. In the secret stable sorting, for example, the method described in the Reference NPL 4 can be used. A vector obtained by executing secret stable sorting on the share [[^{→}eᵢ]] (where i=1, . . . , N) is a vector in which elements from 1st to M−K th are [[0]] and elements from M−K+1-th to M-th are [[1]].

In S130, the third matrix calculation means 130 calculates a share [[S]] of a matrix S=(^{→}s₁, . . . , ^{→}s_{N})^{t} of N rows and K columns (where ^{→}sᵢ (i=1, . . . , N) is a row vector of length K in which evaluation values of a group with respect to K attributes selected at random in the group to which the i-th data ^{→}xᵢ belongs are arranged in a number order of the attributes) from the share [[Y]] calculated in S120. In the calculation of the share [[S]], for example, an Attribute-wise test selection algorithm described in Reference NPL 5 can be used.

In S140, the first vector calculation means 140 calculate a share [[z]] from the share [[S]] calculated in S130 using the share [[Y]] and the share [[U]] calculated in S120. For example, the first vector calculation means 140 calculates the share [[z]] by calculating a share [[^{→}hᵢ]] of a row vector ^{→}hᵢ of length K (where ^{→}hᵢ is a row vector in which an element having a best evaluation value is 1 and the other elements are 0 among elements of ^{→}sᵢ) from the share [[^{→}sᵢ]], calculating a share [[^{→}uᵢ*^{→}hᵢ]] of an inner product ^{→}uᵢ*^{→}hᵢ of ^{→}uᵢ and ^{→}hᵢ from the share [[^{→}uᵢ]] and the share [[^{→}hᵢ]] and setting [[zᵢ]]=[[^{→}uᵢ*^{→}hᵢ]] (i=1, . . . , N).

The secret attribute selection system 10 can be used, for example, for machine learning based on random forest.

According to an embodiment of the present invention, for N pieces of data configured with M pieces of attributes grouped into a predetermined number of groups, it is possible to efficiently perform secret calculation of the selection of the attribute having the best evaluation value from K pieces of attributes selected at random for each group. More specifically, while it is necessary to calculate the evaluation values for all M attributes in the method described in Background Art, calculation of the evaluation values for K attributes in the embodiment of the present invention suffices, and thus it is possible to reduce the number of times of the evaluation value calculation.

### <Supplements>

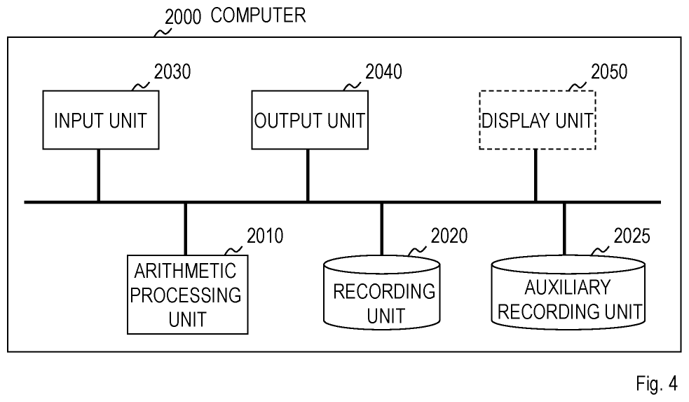

The processing of each unit of each device described above may be implemented by a computer. In this case, processing content of a function of each device is described by a program. Then, various processing functions in each device are implemented on a computer by causing the program to be read in a recording unit 2020 of a computer 2000 illustrated in FIG. 4 and operating an arithmetic processing unit 2010, an input unit 2030, an output unit 2040, an auxiliary recording unit 2025, and the like.

The device according to the present invention includes, for example, as single hardware entities, an input unit to which a signal can be input from the outside of the hardware entities, an output unit from which a signal can be output to the outside of the hardware entities, a communication unit to which a communication device (for example, a communication cable) capable of communicating with the outside of the hardware entities can be connected, a CPU (Central Processing Unit which may include a cache memory and a register) which is an arithmetic processing unit, a RAM or a ROM that is a memory, an external storage device that is a hard disk, and a bus through which data can be exchanged between the input unit, the output unit, the communication unit, the CPU, the RAM, the ROM, and the external storage devices. If necessary, the hardware entities may include a device (drive) capable of reading and writing data from and in a recording medium such as a CD-ROM. An example of a physical entity including such hardware resources is a general-purpose computer.

Programs required for implementing the above-described functions, data required for processing the programs, and the like are stored in the external storage device of the hardware entities (the present invention is not limited to an external storage device and, for example, the programs may be stored in a ROM which is a reading-dedicated storage device). Further, data and the like obtained through processing of the programs are appropriately stored in a RAM, an external storage device, or the like.

In the hardware entities, each program stored in the external storage device (or a ROM or the like) and data required for processing each program are read in a memory as necessary and appropriately interpreted, executed, or processed by a CPU. As a result, the CPU implements predetermined functions (the constituent units described above as units, means, and the like). That is, each of the constituents according to the embodiment of the present invention may be configured by a processing circuitry.

As described above, when the processing functions of the hardware entities (the device according to the present invention) described in the foregoing embodiments are implemented by a computer, the processing content of the functions included in the hardware entities are described using a program. The processing functions of the foregoing hardware entities are implemented by the computer by executing this programs on the computer.

A program describing the processing content can be recorded on a computer-readable recording medium. The computer-readable recording medium is, for example, a non-transitory recording medium and, specifically, a magnetic recording device, an optical disc, and the like.

Distribution of this program is carried out, for example, by selling, transferring, lending, or the like a portable recording medium such as a DVD or a CD-ROM on which the program is recorded. Further, the program may be distributed by being stored in a storage device of a server computer and transferred from the server computer to another computer via a network.

The computer executing such a program first temporarily stores the program recorded in the portable recording medium or the program transferred from the server computer, for example, in an auxiliary recording unit 2025 which is its own non-transitory storage device. Then, when processing is executed, the computer reads the program stored in the auxiliary recording unit 2025 serving as the own non-transitory storage device onto the recording unit 2020, and executes processing according to the read program. As another execution form of the program, the computer may read the program directly from the portable recording medium onto the recording unit 2020, and execute processing according to the program, or the computer may sequentially execute processing according to the program received from the server computer whenever the program is transferred from the server computer to the computer. Instead of transferring the program from the server computer to the computer, the above-described processing may be executed by a so-called ASP (Application Service Provider) type service in which a processing function is implemented by an execution command and result acquisition alone. The program according to the embodiment includes information which is used for processing by a computer and is equivalent to a program (data or the like which is not a direct command for the computer but has a property for defining processing of the computer).

Although the device is configured by executing a predetermined program on a computer in this from, at least part of the processing content may be implemented by hardware.

The present invention is not limited to the above-described embodiment, and appropriate changes can be made without departing from the spirit of the present invention.

1. A secret attribute selection system
wherein N (where N is an integer of 1 or more) is the number of pieces of data, M (where M is an integer of 1 or more) is the number of attributes included in data, X=(^{→}x₁, . . . , ^{→}x_{N}) t (where ^{→}xᵢ (i=1, . . . , N) is a row vector of length M representing i-th data, N pieces of data ^{→}x₁, . . . , ^{→}x_{N} are grouped into a predetermined number of groups, and data belonging to the same group is arranged to be adjacent to each other) is a matrix of N rows and M columns representing N pieces of data ^{→}x₁, . . . , ^{→}x_{N}, and ^{→}g=(g₁, . . . , g_{N})^{t} (where gᵢ (i=1, . . . , N) is 1 in a case where the i-th data ^{→}xᵢ is head data of a certain group and is 0 in other cases) is a column vector of length N representing groups obtained by grouping N pieces of data ^{→}x₁, . . . , ^{→}x_{N},
wherein the secret attribute selection system includes three or more secret attribute selection devices and calculates a share ((^{→}z)) of the column vector ^{→}z=(z₁, . . . , z_{N})^{t} of length N in which an attribute number of an attribute having a best evaluation value among K attributes (where K is an integer of 1 or more and M or less) selected at random in a group to which the i-th data ^{→}xᵢ belongs is an i-th element zᵢ, from a share ((X)) of the matrix X representing N pieces of data ^{→}x₁, . . . , ^{→}x_{N}, and a share ((g)) of the column vector ^{→}g representing groups obtained by grouping the N pieces of data ^{→}x₁, . . . , ^{→}x_{N},
wherein the secret attribute selection system comprises:
a first matrix calculation circuitry configured to calculate, using the share ((^{→}g)), a share ((E)) of a matrix E=(^{→}e₁, . . . , ^{→}e_{N})^{t} of N rows and M columns (where ^{→}eᵢ (i=1, . . . , N) is a row vector of length M representing K attributes selected at random in a group to which the i-th data ^{→}xᵢ belongs, and a j-th element e_{i,j} of the row vector ^{→}eᵢ is 1 in a case where a j-th attribute is a selected attribute and is 0 in other cases),
wherein V=(^{→}v₁, . . . , ^{→}v_{N})^{t} (where ^{→}vᵢ (i=1, . . . , N) is a row vector (1, 2, . . . , M) of length M in which attribute numbers of the attributes of the i-th data ^{→}xᵢ are arranged in a number order of the attributes) is a matrix of N rows and M columns,
a second matrix calculation circuitry configured to calculate, using the share ((E)), a share ((Y)) of a matrix Y=(^{→}y₁, . . . , ^{→}y_{N})^{t} of N rows and K columns (where ^{→}yᵢ (i=1, . . . , N) is a row vector of length K in which values of the i-th data ^{→}xᵢ with respect to K attributes selected at random in a group to which the i-th data ^{→}xᵢ belongs are arranged in a number order of the attributes) from the share ((X)) and calculate, using the share ((E)), a share ((U)) of a matrix U=(^{→}u₁, . . . , ^{→}u_{N})^{t} of N rows and K columns (where ^{→}uᵢ (i=1, . . . , N) is a row vector of length K in which attribute numbers of K attributes selected at random in a group to which the i-th data ^{→}xᵢ belongs are arranged in a number order of the attributes) from the share ((V)),
a third matrix calculation circuitry configured to calculate a share) of a matrix S=(^{→}s₁, . . . , ^{→}s_{N})^{t} of N rows and K columns (where ^{→}sᵢ (i=1, . . . , N) is a row vector of length K in which evaluation values of a group with respect to K attributes selected at random in the group to which the i-th data ^{→}xᵢ belongs are arranged in a number order of the attributes) from the share ((Y)), and
a first vector calculation circuitry configured to calculate a share ((^{→}z)) from the share ((S)) using the share ((Y)) and the share ((U)).

2. The secret attribute selection system according to claim 1,
wherein the first matrix calculation circuitry
generates a share ((D)) of a matrix D=(^{→}d₁, . . . , ^{→}d_{N})^{t} of N rows and M columns (where ^{→}dᵢ (i=1, . . . , N) is a row vector of length M in which K elements selected at random among M elements are 1 and the other M-K elements are 0),
calculates, using the share ((^{→}g)), a share ((D′)) of a matrix D′=(^{→}d′₁, . . . ; ^{→}d′_{N})^{t} of N rows and M columns (where ^{→}d′ᵢ (i=1, . . . , N) is ^{→}dᵢ in a case where gᵢ=1 and is ^{→}0 in a case where gᵢ=0 (here, ^{→}0 is a row vector of length M where all elements are 0)) from the share ((D)), and
calculates a share ((E)) from the share ((D′)) using the share ((^{→}g)).

3. The secret attribute selection system according to claim 1,
wherein the second matrix calculation circuitry
calculates the share ((Y)) by setting a row vector of length K in which elements from M−K+1-th to M-th of a vector obtained through secret stable sorting of the share ((^{→}xᵢ)) with respect to the share ((^{→}eᵢ)) are arranged in order, as the share ((^{→}yᵢ) (i=1, . . . , N) and
calculates the share ((U)) by setting a row vector of length K in which elements from M−K+1-th to M-th elements of a vector obtained through secret stable sorting of the share ((^{→}vᵢ)) with respect to the share ((^{→}eᵢ)) are arranged in order, as the share ((^{→}uᵢ)) (i=1, . . . , N).

4. The secret attribute selection system according to claim 1,
wherein the first vector calculation circuitry
calculates the share ((^{→}z)) by calculating a share ((^{→}hᵢ)) of a row vector ^{→}hᵢ of length K (where ^{→}hᵢ is a row vector in which an element having a best evaluation value is 1 and the other elements are 0 among elements of ^{→}sᵢ) from the share ((^{→}sᵢ)), calculating a share ((^{→}uᵢ*^{→}hᵢ)) of an inner product ^{→}uᵢ*^{→}hᵢ of ^{→}uᵢ and ^{→}hᵢ from the share ((^{→}uᵢ)) and the share ((^{→}hᵢ)) and setting ((zᵢ))=((^{→}uᵢ*^{→}hᵢ)) (i=1, . . . , N).

5. A secret attribute selection device of a secret attribute selection system including three or more secret attribute selection device,
wherein N (where N is an integer of 1 or more) is the number of pieces of data, M (where M is an integer of 1 or more) is the number of attributes included in data, X=(^{→}x₁, . . . , ^{→}x_{N}) t (where ^{→}xᵢ (i=1, . . . , N) is a row vector of length M representing i-th data, N pieces of data ^{→}x₁, . . . , ^{→}x_{N} are grouped into a predetermined number of groups, and data belonging to the same group is arranged to be adjacent to each other) is a matrix of N rows and M columns representing N pieces of data ^{→}x₁, . . . , ^{→}x_{N}, and ^{→}g=(g₁, . . . , g_{N})^{t} (where gᵢ (i=1, . . . , N) is 1 in a case where the i-th data ^{→}xᵢ is head data of a certain group and is 0 in other cases) is a column vector of length N representing groups obtained by grouping N pieces of data ^{→}x₁, . . . , ^{→}x_{N},
wherein the secret attribute selection system calculates a share ((^{→}z)) of the column vector ^{→}z=(z₁, . . . , z_{N}) of length N in which an attribute number of an attribute having a best evaluation value among K attributes (where K is an integer of 1 or more and M or less) selected at random in a group to which the i-th data ^{→}xᵢ belongs is an i-th element zᵢ, from a share ((X)) of the matrix X representing N pieces of data ^{→}x₁, . . . , ^{→}x_{N}, and a share ((^{→}g)) of the column vector ^{→}g representing groups obtained by grouping the N pieces of data ^{→}x₁, . . . , ^{→}x_{N},
wherein the secret attribute selection device comprises:
a first matrix calculation circuitry configured to calculate, using the share ((^{→}g)), a share ((E)) of a matrix E=(^{→}e₁, . . . , ^{→}e_{N})^{t} of N rows and M columns (where ^{→}eᵢ (i=1, . . . , N) is a row vector of length M representing K attributes selected at random in a group to which the i-th data ^{→}xᵢ belongs, and a j-th element e_{i,j} of the row vector ^{→}eᵢ is 1 in a case where a j-th attribute is a selected attribute and is 0 in other cases),
wherein V=(^{→}v₁, . . . , ^{→}v_{N})^{t} (where ^{→}vᵢ (i=1, . . . , N) is a row vector (1, 2, . . . , M) of length M in which attribute numbers of the attributes of the i-th data ^{→}xᵢ are arranged in a number order of the attributes) is a matrix of N rows and M columns,
a second matrix calculation circuitry configured to calculate, using the share ((E)), a share ((Y)) of a matrix Y=(^{→}y₁, . . . , ^{→}y_{N})^{t} of N rows and K columns (where ^{→}yᵢ (i=1, . . . , N) is a row vector of length K in which values of the i-th data ^{→}xᵢ with respect to K attributes selected at random in a group to which the i-th data ^{→}xᵢ belongs are arranged in a number order of the attributes) from the share ((X)) and calculate, using the share ((E)), a share ((U)) of a matrix U=(^{→}u₁, . . . , ^{→}u_{N})^{t} of N rows and K columns (where ^{→}uᵢ (i=1, . . . , N) is a row vector of length K in which attribute numbers of K attributes selected at random in a group to which the i-th data ^{→}xᵢ belongs are arranged in a number order of the attributes) from the share ((V)),
a third matrix calculation circuitry configured to calculate a share ((S)) of a matrix S=(^{→}s₁, . . . , ^{→}s_{N})^{t} of N rows and K columns (where ^{→}sᵢ (i=1, . . . , N) is a row vector of length K in which evaluation values of a group with respect to K attributes selected at random in the group to which the i-th data ^{→}xᵢ belongs are arranged in a number order of the attributes) from the share ((Y)), and
a first vector calculation circuitry configured to calculate a share ((^{→}z)) from the share ((S)) using the share ((Y)) and the share ((U)).

6. A secret attribute selection method:
wherein N (where N is an integer of 1 or more) is the number of pieces of data, M (where M is an integer of 1 or more) is the number of attributes included in data, X=(^{→}x₁, . . . , ^{→}x_{N})^{t} (where ^{→}xᵢ (i=1, . . . , N) is a row vector of length M representing i-th data, N pieces of data ^{→}x₁, . . . , ^{→}x_{N} are grouped into a predetermined number of groups, and data belonging to the same group is arranged to be adjacent to each other) is a matrix of N rows and M columns representing N pieces of data ^{→}x₁, . . . , ^{→}x_{N}, and ^{→}g=(g₁, . . . , g_{N})^{t} (where gᵢ (i=1, . . . , N) is 1 in a case where the i-th data ^{→}xᵢ is head data of a certain group and is 0 in other cases) is a column vector of length N representing groups obtained by grouping N pieces of data ^{→}x₁, . . . , ^{→}x_{N},
wherein the secret attribute selection method calculates, by a secret attribute selection system including three or more secret attribute selection devices, a share ((^{→}z)) of the column vector ^{→}z=(z₁, . . . , z_{N})^{t} of length N in which an attribute number of an attribute having a best evaluation value among K attributes (where K is an integer of 1 or more and M or less) selected at random in a group to which the i-th data ^{→}xᵢ belongs is an i-th element zᵢ, from a share ((X)) of the matrix X representing N pieces of data ^{→}x₁, . . . , ^{→}x_{N}, and a share ((^{→}g)) of the column vector ^{→}g representing groups obtained by grouping the N pieces of data ^{→}x₁, . . . , ^{→}x_{N},
wherein the secret attribute selection method comprises:
a first matrix calculation step of calculating, by the secret attribute selection system, using the share ((^{→}g)), a share ((E)) of a matrix E=(^{→}e₁, . . . , ^{→}e_{N})^{t} of N rows and M columns (where ^{→}eᵢ (i=1, . . . , N) is a row vector of length M representing K attributes selected at random in a group to which the i-th data ^{→}xᵢ belongs, and a j-th element e_{i,j} of the row vector ^{→}eᵢ is 1 in a case where a j-th attribute is a selected attribute and is 0 in other cases),
wherein V=(^{→}v₁, . . . , ^{→}v_{N})^{t} (where ^{→}vᵢ (i=1, . . . , N) is a row vector (1, 2, . . . , M) of length M in which attribute numbers of the attributes of the i-th data ^{→}xᵢ are arranged in a number order of the attributes) is a matrix of N rows and M columns,
a second matrix calculation step of calculating, by the secret attribute selection system, using the share ((E)), a share ((Y)) of a matrix Y=(^{→}y₁, . . . , ^{→}y_{N})^{t} of N rows and K columns (where ^{→}yᵢ (i=1, . . . , N) is a row vector of length K in which values of the i-th data ^{→}xᵢ with respect to K attributes selected at random in a group to which the i-th data ^{→}xᵢ belongs are arranged in a number order of the attributes) from the share ((X)) and calculating, using the share ((E)), a share ((U)) of a matrix U=(^{→}u₁, . . . , ^{→}u_{N})^{t} of N rows and K columns (where ^{→}uᵢ (i=1, . . . , N) is a row vector of length K in which attribute numbers of K attributes selected at random in a group to which the i-th data ^{→}xᵢ belongs are arranged in a number order of the attributes) from the share ((V)),
a third matrix calculation step of calculating, by the secret attribute selection system, a share ((S)) of a matrix S=(^{→}s₁, . . . , ^{→}s_{N})^{t} of N rows and K columns (where ^{→}sᵢ (i=1, . . . , N) is a row vector of length K in which evaluation values of a group with respect to K attributes selected at random in the group to which the i-th data ^{→}xᵢ belongs are arranged in a number order of the attributes) from the share ((Y)), and
a first vector calculation step of calculating, by the secret attribute selection system, a share ((^{→}z)) from the share ((S)) using the share ((Y)) and the share ((U)).

7. A non-transitory computer-readable storage medium which stores a program causing a computer to function as the secret attribute selection device according to claim 5.
